(19) United States
(12) Patent Application Publication
(10) Pub. No.: US 2022/0391830 A1
(43) Pub. Date: Dec. 8, 2022

(54) SYSTEM AND METHOD FOR ADVANCED INVENTORY MANAGEMENT USING DEEP NEURAL NETWORKS

(71) Applicant: RockSpoon, Inc., San Jose, CA (US)

(72) Inventor: Nagib Georges Mimassi, Palo Alto, CA (US)

(21) Appl. No.: 17/842,532

(22) Filed: Jun. 16, 2022

Related U.S. Application Data
(63) Continuation of application No. 17/408,449, filed on Aug. 22, 2021, now abandoned.
Application No. 17/408,449 is a continuation of application No. 17/153,213, filed on Jan. 20, 2021, now Pat. No. 11,276,035.
Application No. 17/408,449 is a continuation of application No. 16/993,488, filed on Aug. 14, 2020, now abandoned.
(60) Provisional application No. 63/162,368, filed on Mar. 17, 2021.
(60) Provisional application No. 63/005,899, filed on Apr. 6, 2020.
(60) Provisional application No. 62/956,289, filed on Jan. 1, 2020.

(51) Int. Cl. G06Q 10/08; G06Q 50/12; G06Q 10/06; G06Q 40/00; G06N 20/00; G06N 5/04; G06Q 10/04; G06Q 10/10; G06Q 20/34; G06Q 40/02

(52) U.S. Cl. CPC G06Q 10/087; G06Q 50/12; G06Q 10/063118; G06Q 40/125; G06N 20/00; G06N 5/04; G06Q 10/04; G06Q 10/1053; G06Q 10/1091; G06Q 20/34; G06Q 40/025; G06Q 10/06311

(57) ABSTRACT

A system and method for advanced inventory management using deep neural networks. The system may be disposed in a business establishment or it may be a cloud-based network comprising a one or more databases to store and retrieve including patron data, recipe data, business data, and inventory data, mobile and compute devices, staff and suppliers, one or more gateways for vendors and staff to interface with other third-party business, and an inventory analysis server. Taken together or in part, optimize organizational operations by predicting and optimizing key inventory decisions using artificial intelligence or other computerized methods around inventory management based upon a large amount of variables associated with the enterprise.

### CROSS-REFERENCE TO RELATED APPLICATIONS

Priority is claimed in the application data sheet to the following patents or patent applications, the entire written description, including figures, of each of which is expressly incorporated herein by reference in its entirety:
U.S. patent Ser. No. 17/408,449
63/162,368
U.S. patent Ser. No. 17/153,213
U.S. patent Ser. No. 16/993,488
62/956,289

### BACKGROUND

### Field of the Art

The disclosure relates to the field of computer-based optimization, predictive systems, and artificial intelligence systems, and more particularly to the field of computerized predictive and optimization systems using artificial intelligence as related to organizational operations for inventory management of organizational establishments.

### Discussion of the State of the Art

Business enterprises often use an inventory management system to track current inventory levels and to be aware of when inventory items should be ordered. The existing systems often track inventory and purchasing to find the lowest cost items to purchase in order to maximize profitability. What these system often lack a broad set of context data that facilitates a holistic approach to inventory management where lowest cost may not be the driving factor making inventory adjustments. Furthermore, these systems often lack the tools to make sense of said context data.

What is needed is a system and method for advanced inventory management which receives a large plurality of data from various sources, which utilizes one or more machine learning algorithms to continuously learn in order to optimize and predict inventory actions, and which generates inventory adjustments based on one or more operational variables.

### SUMMARY

Accordingly, the inventor has conceived and reduced to practice, a system and method for advanced inventory management using deep neural networks. The system may be disposed in a business establishment or it may be a cloud-based network comprising a one or more databases to store and retrieve including patron data, recipe data, business data, and inventory data, mobile and compute devices, staff and suppliers, one or more gateways for vendors and staff to interface with other third-party business, and an inventory analysis server. Taken together or in part, optimize organizational operations by predicting and optimizing key inventory decisions using artificial intelligence or other computerized methods around inventory management based upon a large amount of variables associated with the enterprise.

According to an embodiment, a system for advanced inventory management is disclosed, comprising: A system for advanced inventory management, comprising: an inventory analysis server comprising at least a plurality of programming instructions stored in a memory of, and operating on at least one processor of, a computing device, wherein the plurality of programming instructions, when operating on the at least one processor, cause the computing device to: receive a plurality of stored and third-party data comprising inventory, patron, supplier, social media, and business information and use machine learning to; analyze at least a portion of the received data to determine the quantity of items to be purchased and to predict future inventory requirements; analyze at least a portion of the received data to determine optimal inventory levels; generate a plurality of inventory adjustment suggestions based on the determined quantity of times to be purchased, patron data, inventory data, and third-party data comprising at least one of: local news and events, current and forecasted weather, a social media posting, or a rating or review; generate a smart shopping list based on the determined quantity of items to be purchased and the inventory adjustment suggestions; and analyze at least a portion of the received data to determine a break-even point and to predict a dynamic point of reorder.

According to an embodiment, a method for advanced inventory management is disclosed, comprising the steps of: receiving a plurality of stored and third-party data comprising inventory, patron, supplier, social media, and business information and use machine learning to; analyzing at least a portion of the received data to determine the quantity of items to be purchased and to predict future inventory requirements; analyzing at least a portion of the received data to determine optimal inventory levels; generating a plurality of inventory adjustment suggestions based on the determined quantity of times to be purchased, patron data, inventory data, and third-party data comprising at least one of: local news and events, current and forecasted weather, a social media posting, or a rating or review; generating a smart shopping list based on the determined quantity of items to be purchased and the inventory adjustment suggestions; and analyzing at least a portion of the received data to determine a break-even point and to predict a dynamic point of reorder.

According to various embodiments; the business data comprises at least one of: point of sale data for a plurality of sales transactions, accounts receivable information for a plurality of suppliers, accounts payable information for a plurality of suppliers, financial account information for a plurality of banking institutions, or time and location descriptors; the inventory data comprises at least one of: a quantity of an item on-hand, a par level, a last re-order date, an expiration date, a shelf life value, or a forecasted reorder date; real-time third-party data, the real-time third-party data comprising at least one of: local news and events, current and forecasted weather, a social media posting, or a rating or review; and stored patron data comprising at least one of: a food item previously purchased, day and time data, weather conditions, local news and events, or preferences; the inventory adjustment suggestions generate menu adjustments for a restaurant based on patron trends, inventory availability, and external events; the machine learning comprises a long short term memory neural network.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture for advanced inventory management, according to one embodiment.

FIG. 2 is a block diagram illustrating in more detail an exemplary system architecture for advanced inventory management, according to an embodiment.

FIG. 3 is a flow diagram showing an exemplary algorithm for implementation of a system for advanced inventory management, according to an embodiment.

FIG. 4 is a block diagram illustrating an exemplary connection between two restaurants which both use the advanced inventory management system, according to an embodiment.

FIG. 5 is a diagram of an exemplary smart shopping list generated using an advanced inventory management system and presented via a user interface, according to an embodiment.

FIG. 6 is a flow diagram showing the steps of an exemplary method for advanced inventory management for a restaurant business from initial receipt of supplier data through sending smart shopping lists to suppliers for order fulfillment.

FIG. 7 is a flow diagram showing the steps of an exemplary method for advanced inventory optimization for a restaurant business from initial receipt of supplier data through recommending menu adjustments.

FIG. 8 is a block diagram illustrating an exemplary hardware architecture of a computing device.

FIG. 9 is a block diagram illustrating an exemplary logical architecture for a client device.

FIG. 10 is a block diagram showing an exemplary architectural arrangement of clients, servers, and external services.

FIG. 11 is another block diagram illustrating an exemplary hardware architecture of a computing device.

### DETAILED DESCRIPTION

The inventor has conceived, and reduced to practice, a system and method for advanced inventory management using deep neural networks. The system may be disposed in a business establishment or it may be a cloud-based network comprising a one or more databases to store and retrieve including patron data, recipe data, business data, and inventory data, mobile and compute devices, staff and suppliers, one or more gateways for vendors and staff to interface with other third-party business, and an inventory analysis server. Taken together or in part, optimize organizational operations by predicting and optimizing key inventory decisions using artificial intelligence or other computerized methods around inventory management based upon a large amount of variables associated with the enterprise.

While the use case of a restaurant business owner optimizing their business operations is a primary example used herein, it is important to note that the invention is not so limited, and may be used by any business (i.e., the invention is not limited to restaurants, and can be applied to any retail goods, such as grocery stores, on-line and/or brick and mortar; service business, such as home cleaning, lawn care, financial services) seeking to optimize their cash flows, staff and inventory in a real-time fashion. Additionally, while data ingestion, optimization, and prediction is generalized to machine-learning, it is known in the art that many machine-learning algorithms and methods may be implemented to perform the same function with only a difference in performance or other properties not tied to the outcome of the algorithm.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features.

Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“Business establishment” or “place of business” as used herein mean the location of any business entity with which customers may transact business. Typically, this will be a physical location where customers may enter the location and transact business directly with employees of the business, however, it may also be a delivery-based business. Many examples herein use a restaurant as the business establishment, but the invention is not limited to use in restaurants, and is applicable to any business establishment. “Patron” is used to reference the customer or prospective customer of the business establishment. “Staff” is used to reference the employee or contractor of the business establishment.

Conceptual Architecture

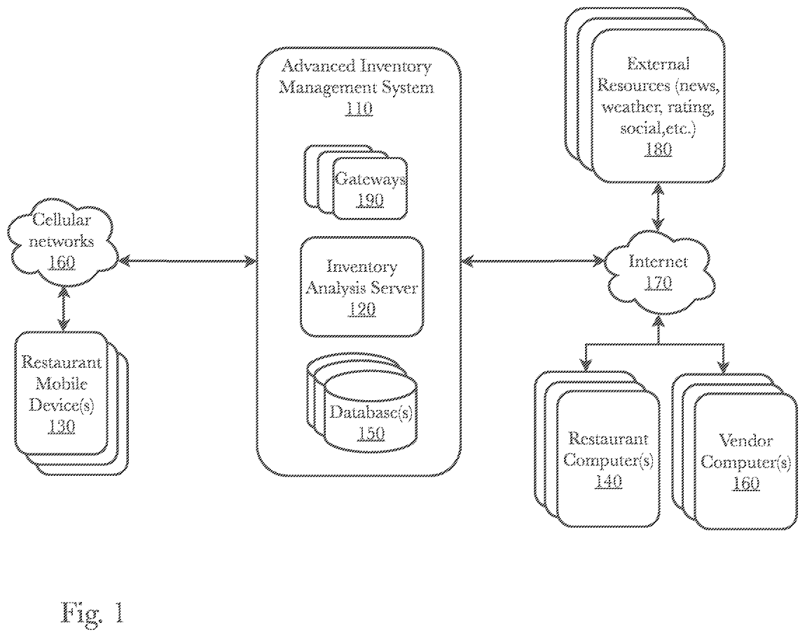

FIG. 1 is a block diagram illustrating an exemplary system architecture for an advanced inventory management system 110, according to one embodiment. According to an embodiment, and using a restaurant as an exemplary business establishment, system comprises an inventory analysis server 120, one or more gateways 190, and one or more databases 150. Restaurant mobile devices 130 may connect to advanced inventory management system 110, typically via a cellular phone network 160, although connections may be made through other means, as well, such as through Internet 170 (e.g., through a Wi-Fi router). Restaurant computers 140 and/or vendor computers 160 may connect to advanced inventory management system 110, typically through an Internet 170 connection, although other network connections may be used. Gateways 190 may be used to provide integration with third-party or external systems. For example, advanced inventory management system 110 may comprise a supplier gateway which facilitates integrating a supplier's internal system, which may contain information such as available stock and its quantity and price points, with advanced inventory management system 110 in order to provide accurate and real-time supplier information to the inventory analysis server 120.

According to an aspect, a restaurant may access restaurant computer 140 to enter or update a variety of financial information that may include lease hold costs, loaded labor rates, cost of goods, sold menu items, recipe information, inventory on-hand, staff, staffing needs, culinary skill requirements along with other information that may be stored in a database 150, and used by inventory analysis server 120 that may suggest and optimize inventory actions to optimize business operations around one or more business metrics.

Similarly, according to an aspect, a restaurant may access restaurant computer 140 to enter or update a variety of inventory information that may include current inventory on hand, re-order levels, expected usage and so on along with other information that may be stored in a database 150, and used by advanced inventory management system 110 that may offer or execute inventory related actions to optimize inventory operations around one or more business metrics. According to one aspect, point-of-sale devices may automatically update inventory information in real-time after the completion of a transaction.

Furthermore, according to another aspect, a restaurant manager may access restaurant computer 140 to enter or update a variety of operational information that may include staffing needs, training needs, hours of operations, upcoming market events and so on along with other information that may be stored in a database 150, and used by advanced inventory management system 110 that may consider staffing data to optimize business operations around one or more staffing metrics. Other such real-time information and factors may also be determined by system through access to one or more external resources 180 such as a utility provider that may include current usage, current rates, balance due and so forth. Other exemplary external resources may comprise public data services or sources such as weather service, social media platforms, news outlets and rating services.

Likewise, vendors may access vendor computer 160 to enter information about service or product provided, invoice information, credit terms and any current or upcoming promotions along with other information. Examples of the types of information that a vendor may enter include, but are not limited to: restaurant name, location, types of food item provided (e.g. rice, beans, wagyu beef, scallions, grass fed young chickens, chicken liver pate, cod liver oil), type of non-food item provided (e.g. 12 oz paper cups, 9 inch paper dinner plate, bleach, lemon wax, rubbing alcohol) service offered (e.g. uniform service, landscaping maintenance), item pricing, credit terms, special pricing options like volume discounting daily specials or seasonal offerings. In some aspects, the system may be able to determine certain information by accessing external resources 180 such as mapping websites and applications. For example, system may access a publicly-available mapping website such as Google maps, which may contain information about the restaurant's name, location, types of food offered, hours of operation, phone number, etc. Thus, in some aspects, it is not necessary for the restaurant to enter certain information through portal, as the information may be automatically obtained from external resources 180.

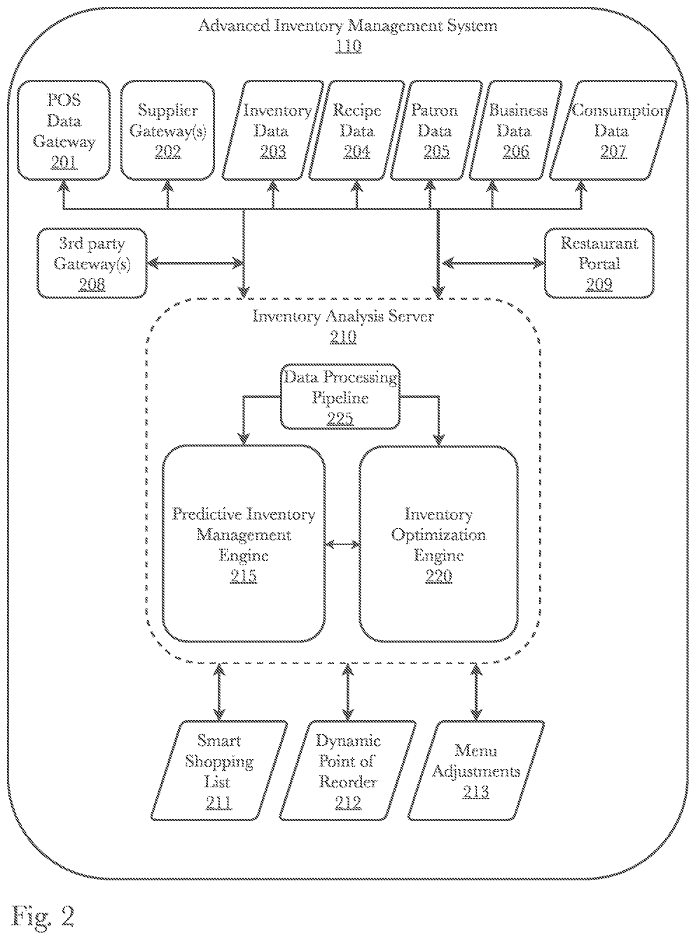

FIG. 2 is a block diagram illustrating in more detail an exemplary system architecture for advanced inventory management, according to an embodiment. According to an embodiment, advanced inventory management system 110 comprises an inventory analysis server 210 which may further comprise a predictive inventory management engine 215, an inventory optimization engine 220, and a data processing pipeline 225. The predictive inventory management engine 215 and the inventory optimization engine 220 may comprise one or more machine learned algorithms. Inventory analysis server 210 may connect, for bi-lateral data exchange, to a point-of-sale (“POS”) data gateway 201, a supplier gateway 202; may receive inventory data 203, recipe data 204, patron data 205, business data 206 and consumption data 207; establish a bi-lateral data exchange with a 3^{rd} party gateway 207 and restaurant portal 208; and may provide as outputs a smart shopping list 211, dynamic point of reorder recommendations 212, and menu adjustments 213.

POS data gateway 201 may be used to integrate with POS devices utilized by a restaurant to provide to advanced inventory management system 110 sales data which can be used by the inventory analysis server 210 to track and determine current inventory levels related to sold menu items. Distributor gateway(s) 202 may be used to integrate with a plurality of suppliers to access supplier data including, but not limited to, available items for purchase, quantity of items, cost of items, volume/bulk pricing scheme, seasonal items, delivery and payment characteristics (e.g., cash only, net seven or net fifteen, payment on delivery, delivery schedule, etc.), and lead times on certain items. In addition, supplier gateway(s) 202 may be used to send a smart shopping lists 211 and reorders to suppliers.

Third-party gateway(s) 208 may provide a plurality of information related to external demand factors such as (but not limited to) weather, social media, current events both locally (e.g., sporting event happening, farmers market, harvest information for local farms, publications in newspaper or magazine, local news feature, etc.) and non-locally (e.g., trade agreements that may affect inventory items, new rules or regulations that may impact business such as COVID-19 restrictions, catastrophic event, etc.). Third-party gateway(s) 208 may include application programming interfaces (“APIs”) and web scrapers to retrieve (e.g., collect, query, aggregate, or otherwise obtain) data from various third-party systems, sources, and databases. For example, a web scraper may be used to scan social media feeds to identify and retrieve information related to a restaurant (e.g., reviews, likes, mentions, hashtags, links, shares, pictures, etc.) and store the information in database(s) 150. Then the advanced inventory management system 110 may perform sentiment analysis on the scraped social media information to provide more context about a restaurant's operations. According to an embodiment, sentiment data may be sent with all other data to inventory analysis server 210 to generate inventory related predictions and optimizations.

According to an embodiment, restaurant portal 209 may provide an interface where restaurant staff (i.e., manager) can view and interact with the outputs of the advanced inventory management system 110. For example, the system generates a smart shopping list 211 for each day of a given week and sends the shopping list to the restaurant portal where it may be reviewed by a manger before being sent to a supplier. In this way, restaurant portal 209 allows for managerial discretion and final say on all system outputs. Any changes made by a manger to the generated smart shopping list 211 may be captured by the advanced inventory management system 110 to provide more context feedback data for the inventory analysis server 210 to improve upon the machine learning (“ML”) algorithms that generate the smart shopping list 211. Additionally, the restaurant portal 209 may also be utilized by a restaurant to provide information related to inventory, staffing, finances, and sales.

According to an embodiment, inventory analysis server 210 may receive a plurality of data including, but not limited to: external data such as weather, current and special events, and social media, supplier data, inventory data 203, recipe data 204, patron data 205, consumption data 207, and business data 206, such as, for example financial data related to marginal cash flow and payroll timing to name a few. Restaurant inventory data 203 may include, but is not limited to, current inventory, quantity of inventory items, purchase price of inventory items, purchase and delivery date, expiration date or shelf life of item, etc. Recipe data 204 may include, but is not limited to, an ingredient list, a time to prepare (e.g., ten minutes, forty-five minutes, etc.), ingredient substitutions (e.g., lasagna may be made to include meat or vegetables), and recipe yield (e.g., tomato sauce yields enough sauce for fifty dishes, twelve baguettes, etc.). Patron data 205 may include, but is not limited to, order or purchase history, address, phone number, comments, requests, reviews, reservation information such as, for example party size and time of reservation, preferences, and other information.

Patron data 205 may be collected from restaurant computer 140 and POS data gateway 201, and may be stored in database 150. In an embodiment, patron data 205 may be collected from an application associated with the restaurant that facilitates a patron to order food from, make reservations at, leave reviews for, or post on social media about the restaurant. Additional patron data 205 may be collected from social media or inferred from the analysis of social media data via machine learned algorithms. For example, a patron may make a post on social media, such as INSTAGRAM™, about a menu item they just ate at a restaurant, the post could include a picture of the dish, one or more hashtags, and a comment about the food. In this example, the advanced inventory management system 110 may access social media platforms using an API and then retrieve the data and metadata (e.g., time of post, location, etc.) associated with the social media post. For example, a patron makes a social media post containing a picture of a dish that was eaten along with a comment including one or more hashtags (e.g., #RESTAURANTNAME, #DELICIOUS, #SOGOOD, #OVERRATED, etc.) and the advanced inventory management system 110 can determine the sentiment of the patron in regards to the dish or restaurant using the comment and hashtags as input into machine learned algorithms such as a natural language processing (“NLP”) neural network. In some embodiments, a patron profile may be created in database 150 to collate all data related to a given patron.

Consumption data 207 may be collected or derived from POS data gateway(s) 201, patron data 205, business data 206, and external sources, among others. Consumption data 207 may be used by the advanced inventory management system 110 to determine consumption patterns across a large plurality of metrics such as, for example consumption patterns based upon the time of day or weather. As an example of derived consumption data 207, the inventory analysis server 210 may determine that patron consumption has a ten percent decrease on rainy days, whereas patron consumption increases by ten percent on days when the local football team plays a game. Consumption data 207 may be utilized by the inventory analysis server 210 to determine a dynamic point of reorder 212 for a particular menu or inventory item.

According to an embodiment, inventory analysis server 210 may collect, parse, and clean a large plurality of data via a data processing pipeline 225, extracting and receiving data from at least one of the following sources selected from the non-limiting list of: the database 150, POS data, supplier data 202, inventory data 203, recipe data 204, patron data 205, business data 206 consumption data 207, and external and third-party data. Once the large plurality of data is preprocessed, it may be sent for ingestion into one or more machine learning algorithms located within the predictive inventory management engine 215 and inventory optimization engine 220. Various exemplary algorithms are described herein but are not limited to only those disclosed.

According to an embodiment, advanced inventory management system 110 may generate smart shopping list 211, dynamic point of reorder 212, and menu adjustments 213 as outputs of the system. These outputs may be sent to a restaurant portal 209 so that restaurant staff (i.e., manager) may view and interact with the outputs via an interface using restaurant mobile device 130, restaurant computer 140, or any other suitable computing device connected to the system. The interface may be a graphical user interface, or any other suitable interface known in the arts. The restaurant manager can view the outputs for final approval or if necessary revision. The manager may choose to either manually execute the output suggestions (e.g., email smart shopping list 211 or reorder request to appropriate supplier, make menu adjustments, etc.) or to have advanced inventory management system 110 execute the output suggestions automatically upon manger approval or revision. For example, a manager may view on a restaurant computer 140 a smart shopping list 211 and a suggested menu adjustment 213 wherein the manager decides to manually email the smart shopping list to the supplier, but allows the advanced inventory management system 110 to automatically execute the menu adjustment 213. In some embodiments, the advanced inventory management system 110 may be configured to execute output suggestions without waiting for managerial approval, this may be applied on a per output basis (e.g., only allow execution of reorders without approval).

According to an embodiment, advanced inventory management system 110 may generate, via various machine learned algorithms, smart shopping list 211 which may be determined and optimized around one or more business metrics. Every time restaurant staff access the smart shopping list 211, it is automatically updated with suggested quantities for each item and suggested supplier from which to purchase the listed items. The system is designed to take a holistic approach to generating suggestions for a list, not merely which supplier has the cheapest cost items (although profitability and financial viability may be among the variables included for generating suggestions). A smart shopping list 211 may generated per supplier, but optimized between suppliers. For example, a shopping list for a first supplier is generated for tomorrow and it determines to buy one third of the needed tomato sauce tomorrow, and to buy the rest from a second supplier in three days, in order to optimize the cash flow of the restaurant.

According to an embodiment, advanced inventory management system 110 may determine a dynamic point of reorder 212 for certain prepared items on the menu. The point of reorder is the point below normal inventory levels when a new batch of something should be reordered or prepared. The dynamic point of reorder 212 may be based on the following, but is not limited to, the time of week or day, minimum batch size, shelf life of food item, inventory data, time to produce food item, consumption data, weather, and special external factors such as holiday or trend days inferred from models. Pre-prepared items ones the restaurant purchases from a supplier as they are, but some are pre-prepared but require some different work (e.g., making tomato sauce or a cake that arrives whole but need to be cut into eight slices) before vending. For example, consider a bakery that pre-prepares the baguettes for a restaurant and each morning there is a standard set of items to start baking. The restaurant may receive the standard set of items from the bakery and then using the advanced inventory management systems 110 it starts measuring what is happening during the day via the above described data components. As the system gathers statistics, it can also take into account time it takes to produce the baguettes, what the consumption per hour is, the shelf life, and the break-even point in order to dynamically change the point of reorder. Continuing the example, the restaurant reaches a point of reorder an hour before it closes and it takes forty-five minutes to prepare a batch of baguettes which means it is not tenable to execute a reorder on the baguettes. Sometimes it may make sense to reorder a partial batch. For instance, the system may determine to reorder a partial batch at ninety minutes before close to ensure baguettes are available for late patrons. The target amount of reorder size adjusts during the evening so no waste occurs such that at five in the evening the point of reorder may be fifty baguettes, then at seven in the evening the point of reorder may be thirty baguettes, and so on. The dynamic point of reorder 212 can be approved or denied by the manager. The restaurant manager can send a request at any time to the prepare X amount items of Y from the bakery based upon the dynamic point of reorder 212.

According to an embodiment, advanced inventory management system 110 may generate menu adjustments 213 in order to optimize business operations according to one or more business metrics. For example, menu adjustments 213 may be determined and optimized based on profitability or freshness of ingredients. In some embodiments, the system may be able to view patron data associated with the weekend reservations in order to make menu adjustment based on patron purchase history. For example, the reservation list for Friday and Saturday night dinner service may include many revisiting patrons who have expressed (through comments to restaurant staff, or social media reviews and comments) that they enjoyed a particular pasta dish that was once offered as a special menu item. The system may, for that weekend, suggest adding the pasta dish to the menu as a weekend special in order to enhance the experience and sentiment of the patrons. Other menu adjustments may be made in response to inventory items nearing their expiration date or shelf life, or to take advantage of seasonal offerings.

Inventory analysis server 210 utilizes various ML algorithms to perform a variety of actions to facilitate predictive inventory management and optimization tasks such as smart shopping list 211 generation, dynamic point of reorder 212, and menu adjustments 213. For example, an NLP neural network may be created to analyze and determine sentiment in regards to a restaurant and its menu items based upon ingested (non-limiting) social media data, website reviews, and media mentions such as newspaper or magazine articles and television news reports. Sentiment data may be used, in conjunction with a large plurality of various other data, as inputs into another ML algorithm to suggest inventory actions 211, 212, 213. According to one embodiment, the predictive inventory management engine 215 one or more long short term memory (LS™) neural network, which is a special recurrent neural network (RNN), may be implemented to generate inventory based predictive and optimized outputs from the predictive inventory management engine 215 and the inventory optimization engine 220. LS™ neural networks are well suited to generate suggestions (i.e., predictions) in response to a large plurality of variables spanning a massive collection of heterogenous information. Particularly, the inclusion of memory in the LS™ neural network makes it useful for analyzing and optimizing time-series data due to its inherent ability to save previous states for long periods of time. Inventory management may be considered a time-series prediction and optimization task because, historically, inventory management has been conducted using knowledge of the past to forecast the needs of the present or future. For example, when considering what to order for from a supplier, a restaurant manager will typically plan according to his or her previous experience. In this example, the manager may be planning his next inventory supply purchase based on last month's or last week's sales data in order to identify the correct amount of inventory to purchase.

The advanced inventory management system 110 uses ML algorithms in combination with a large swath of data and context to take an all-inclusive approach to inventory prediction and optimization by looking at all dimensions of a restaurant, its distributors, and its patrons in order to learn constantly. In this way the system can enhance traditional inventory forecasting in order to produce real-time, dynamic predictions and optimizations. In other embodiments, different Deep Learning algorithms such as elastic net, random forest, or gradient boosting models or other Artificial Intelligence techniques known to those skilled in the art may be implemented in the advanced inventory management system 110.

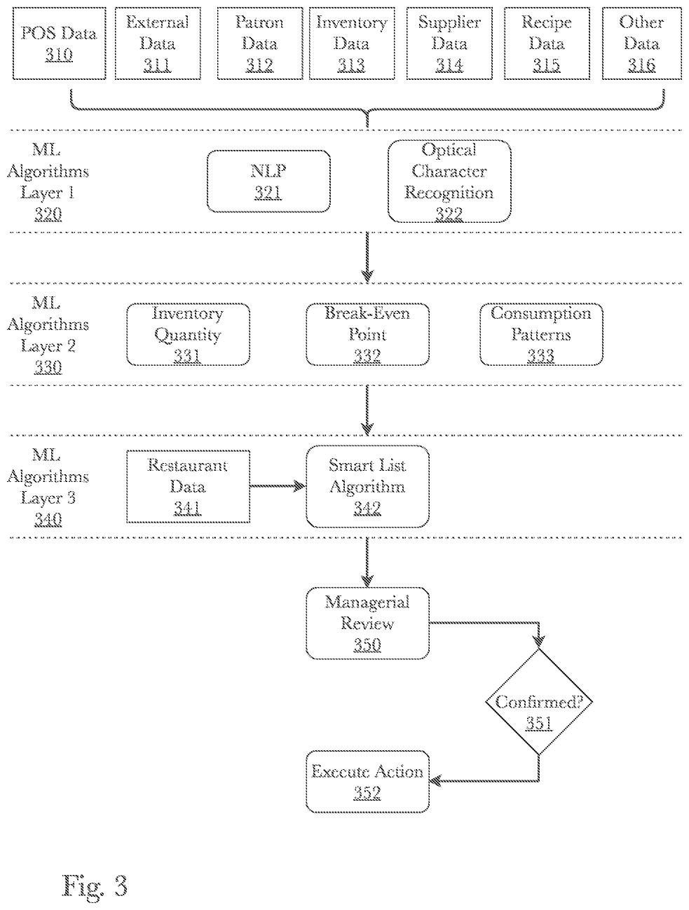

FIG. 3 is a flow diagram showing an exemplary algorithm for implementation of a system for advanced inventory management, according to an embodiment. External data 311 and patron data 313 informing machine learning algorithms 321 and 322 may come from a patron's mobile device, social media accounts, or from comment cards left filled out by a patron at a restaurant. External data 311 may include, but is not limited to, third-party data such as local news and events, current and forecasted weather, social media postings, and a rating or review and may inform machine learning algorithms 321 and 322 through APIs or via a web scraper tool. Other data 316 may comprise data gathered by data brokers or offered by other data purveyors, where said other data may be grocery store data, online purchase history, and other relevant information to a customer's preferences and behaviors.

The data described in the above paragraph may be used to inform a first layer of machine learning algorithms 320. Natural language processing algorithms 321 allow the system to understand intentions and sentiments, optical character recognition algorithms 322 allow the system to read handwritten comment cards submitted to the restaurant by a patron, and then use NLP algorithms to extract sentiment from the handwritten comment cards. The combination of these algorithms 321 and 322 may be used by a long short term memory based neural network 330 to learn the optimal inventory quantity 331, break-even point 332 for determining batch sizes of menu items, and consumption patterns 333 which better allow the decision making of the system to suggest the best inventory adjustments based on the context of the decision and business need. As an example, the patron data associated with restaurant reservations for the weekend may be analyzed to determine their sentiment towards the restaurant or particular menu items, and then the system may suggest menu adjustments based, in part, on the determined sentiment of the reservation guests.

An additional machine learning algorithm layer 340 comprises a smart shopping list algorithm 342 developed using the LS™ neural network, informed with inventory quantity 331, break-even point 2033, and sentiment of patrons, as well as restaurant data 341 comprising external data 311, patron data 312, inventory data 313, point of sales data 310, recipe data 315, and supplier data 314 may build a model that can suggest optimized smart shopping list recommendations.

As the system identifies inventory needs and further suggests inventory adjustments, those adjustments may be sent to a manager for review 350 via a restaurant mobile device or restaurant computer. A manager may confirm, edit, or reject 351 an inventory adjustment via the system on his or her mobile device. Upon confirmation or rejection 351 various modules within the system may be notified 352 to execute the action. For example, if a manager accepts a smart shopping list, the system will receive a notification 352 and may send to a supplier for order fulfillment. Notification 352 of the rejection, edit, of confirmation also is fed back into the inventory analysis server to better learn how to manage inventory.

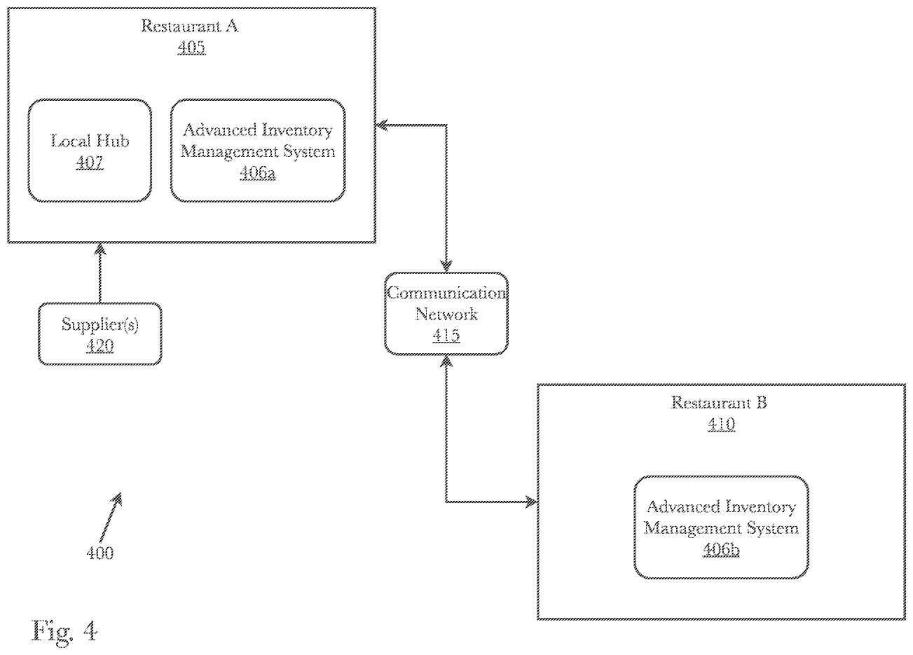

FIG. 4 is a block diagram illustrating an exemplary connection between two restaurants 400 which both use the advanced inventory management system, according to an embodiment. According to an embodiment, two or more business which utilize advanced inventory management system 406a-b may connect with each other via a communication network 415. Communication network 415 may include, but is not limited to, the internet, cellular phone networks such as code division multiple access (“CDMA”) or global system for mobiles (“GSM”), or any other suitable communication network known to those in the art. Restaurant A 405 and restaurant B 410 may make use of economies of scale and jointly place an order for a group of restaurants from suppler(s) 420 in a large bulk order. One of the participating businesses may act as a local distribution hub 407 that receives the joint bulk order from the supplier(s) 420 on behalf of the other participating businesses so that business may go to the local hub 407 business and retrieve their orders. This allows businesses located within close proximity to each to bulk order and distribute among themselves. Furthermore, connecting business through the advanced inventory management system 406a-b allows business to also be suppliers. For example, restaurant A has over-ordered tomatoes, but restaurants nearby need some tomatoes and so restaurant A may be able to sell its excess tomatoes to nearby restaurants via the advanced inventory management system 406a-b.

### Detailed Description of Exemplary Aspects

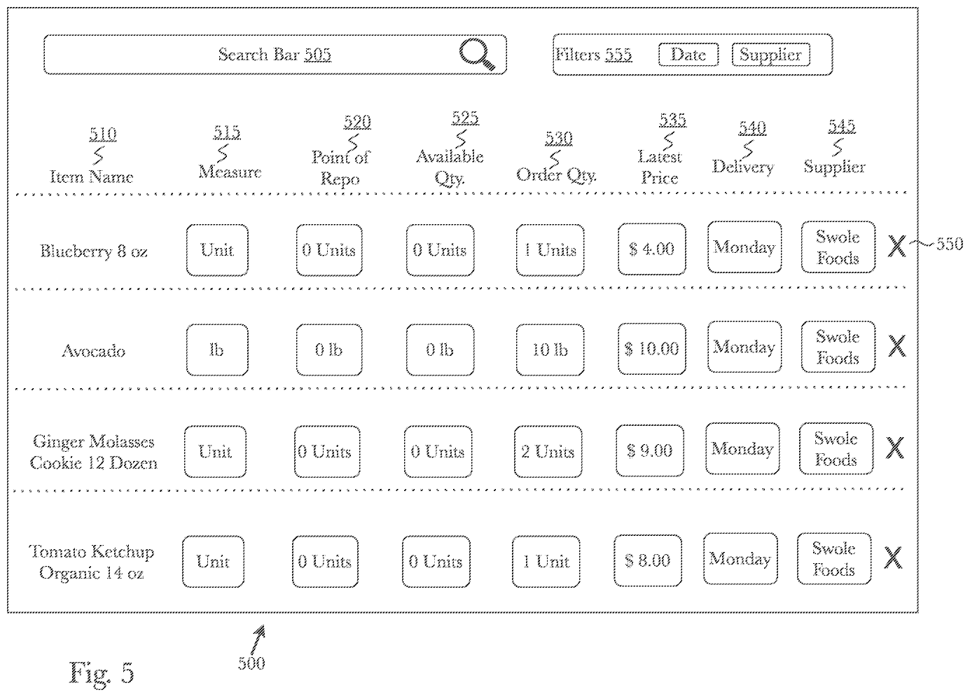

FIG. 5 is a diagram of an exemplary smart shopping list 500 generated using an advanced inventory management system and presented via a user interface, according to an embodiment. According to an embodiment, advanced inventory management system 110 may generate a smart shopping list 500 that may be displayed to restaurant staff via a restaurant mobile device or restaurant computer. Smart shopping list 500 is continuously updated in real-time to reflect the ever-changing inventory needs of a restaurant using various ML algorithms. The smart shopping list 500 may provide a search bar 505 that allows a system user to search for a variety of inventory related objects. System users may be able to: search for items in their current inventory, search of purchasable items offered by suppliers, search for specific items, search by specific supplier, search by recently added items, search by seasonal items, search via delivery or payment characteristics, search by date, etc. The search bar 505 allows users to quickly search and find available information from multiple suppliers in a centralized hub allowing for improved efficiency via time saved in the search process and makes for easier comparison of price points between and among multiple suppliers.

Smart shopping list 500 may provide a variety of fields that help organize items on the list. Some exemplary fields may include, but are not limited to, item name 510, measure 515, point of repurchase 520 which describes the minimum acceptable level of inventory for an item at which point it needs to be reordered, available quantity 525 which describes the amount of an item currently in restaurant inventory, order quantity 530 which describes the amount of an item to be ordered, latest price 535 reflects the current price point for the item, delivery 540 which describes the date of delivery, and supplier 545. Order quantity 530 may be determined using one or more of the various ML algorithms implemented by the advanced inventory management system 110 and can change throughout the day based upon the data received by the system. In some embodiments, the displayed fields may be configurable at the discretion of the restaurant manager in order to suit the operations of a particular restaurant. Smart shopping list 500 may also provide one or more filters 555 that allow a system user to view or access lists depending upon a selected filter setting such as by (the non-limiting) date of delivery or supplier, to name a few. Smart shopping list 500 allows for a restaurant manager to approve, decline, or otherwise amend the list at his or her discretion. For example, the manager may be able to adjust any of the values displayed in any of the fields for any item on the list, or otherwise remove an item from the list using a delete item action 550 such as a delete button. In some embodiments, shopping lists may be automatically submitted to participating, integrated suppliers.

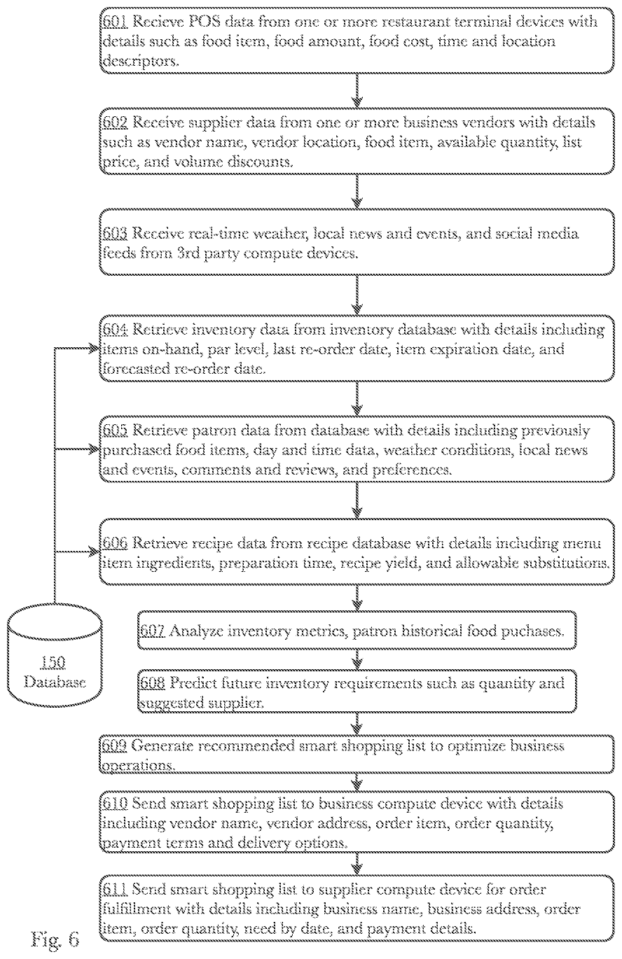

FIG. 6 is a flow diagram showing the steps of an exemplary method for advanced inventory management process. In a first step, 601 receive point-of-sales (“POS”) data from a plurality of business computing devices for one or more sales transactions, POS data for each sales transaction comprising food item, food amount, food cost, time and location descriptors. In a next step, 602 receive supplier data from a plurality of business computing devices for one or more supplier business entities, supplier data for each supplier business entity comprising vendor name, vendor location, food item, available quantity, list price, volume discounts, payment and delivery characteristics. In a next step, 603 receive real-time 3^{rd} party data from a plurality of business computing devices for one or more data sources, the 3^{rd} party data comprising local news and events, current and forecasted weather, social media feeds, rating and review sites. In a next step, 604 retrieve inventory data from inventory database, inventory data comprising items on-hand, par level, last re-order date, expiration date, forecasted re-order date, item expiration date. In a next step, 605 retrieve patron data from patron profile database, patron data comprising food items previously purchased, day and time data, weather conditions, local news and events, comments and reviews, and preferences. In a next step, 606 retrieve recipe data from recipe database, recipe data comprising menu item ingredients, preparation time, recipe yield, and allowable substitutions. In a next step, 607 analyze inventory metrics, patron historical food purchase history. In a next step, 608 predict future inventory requirements. In a next step, 609 generate recommended smart shopping list to optimize business operations. In a next step, 610 send recommended smart shopping list to business compute device, recommended smart shopping list comprising vendor name, vendor address, order item, order quantity, payment terms delivery options available. In a next step, 611 send recommended smart shopping list to supplier business compute device for order fulfillment, recommended smart shopping list comprising vendor name, vendor address, order item, order quantity, payment terms delivery options available.

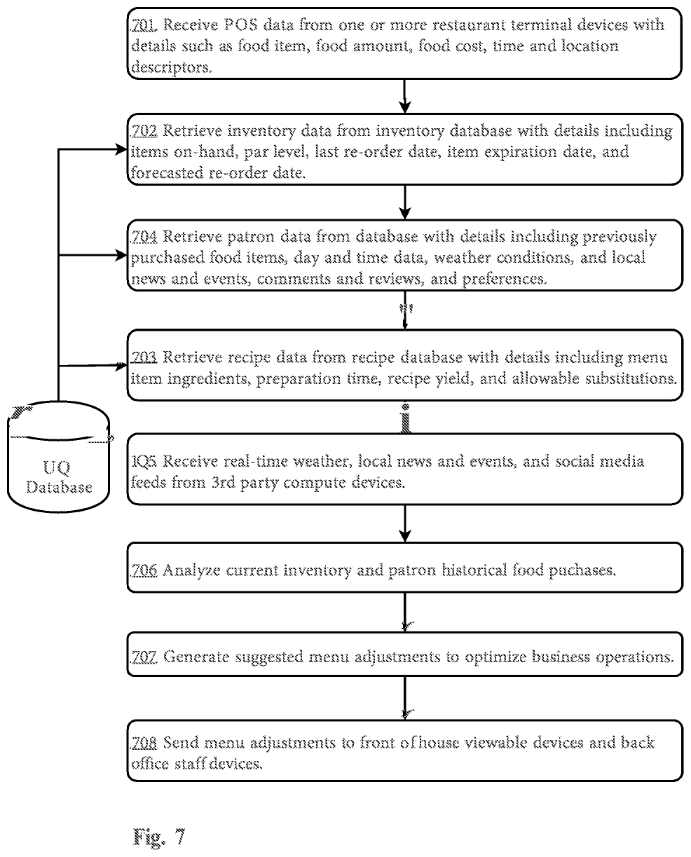

FIG. 7 is a flow diagram showing the steps of an exemplary method for inventory optimization process. In a first step, 701 receive point-of-sales (“POS”) data from a plurality of business computing devices for one or more sales transactions, POS data for each sales transaction comprising food item, food amount, food cost, time and location descriptors. In a next step, 702 retrieve inventory data from inventory database, inventory data comprising items on-hand, par level, last re-order date, expiration date, forecasted re-order date. In a next step, 703 retrieve recipe data from recipe database, recipe data comprising menu item ingredients, preparation time, recipe yield, and allowable substitutions. In a next step, 704 retrieve patron data from patron profile database, the patron data comprising food items previously purchased, day and time data, weather conditions, surrounding circumstances including local news and events. In a next step, 705 receive real-time 3^{rd} party data from a plurality of business computing devices for one or more data sources, the 3^{rd} party data comprising local news and events, current and forecasted weather, social media feeds, rating and review sites. In a next step, 706 analyze inventory metrics, patron food purchase history and predict inventory requirements using Deep Learning algorithms such as long short term memory neural network, elastic net, random forest, or gradient boosting models or other Artificial Intelligent techniques known to those skilled in the art. In a next step, 707 generate recommended menu adjustments to optimize business operations. In a next step, 708 send recommended menu adjustments to business compute device, the recommended menu adjustments comprising food item name, price, promotion information.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

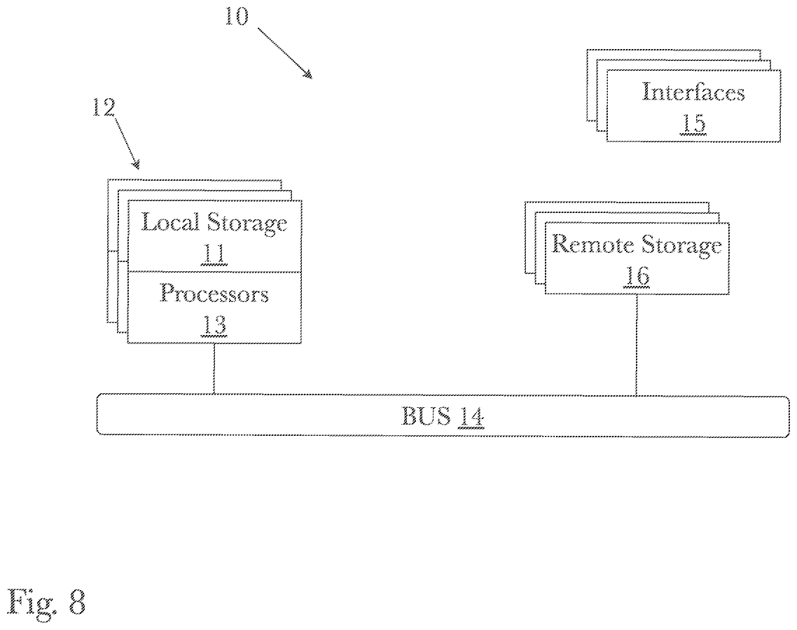

Referring now to FIG. 8, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 8 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably.

Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

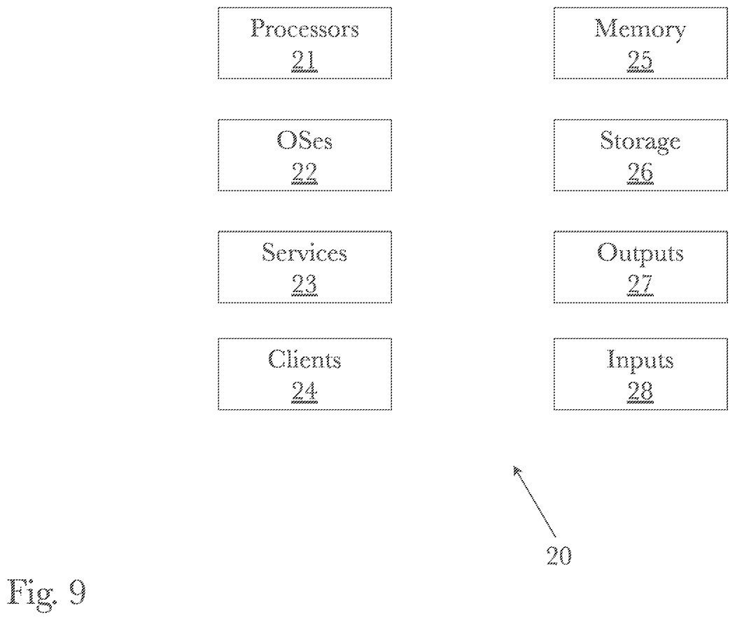

In some aspects, systems may be implemented on a standalone computing system. Referring now to FIG. 9, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 8). Examples of storage devices 26 include flash memory, magnetic hard drive, CD-ROM, and/or the like.

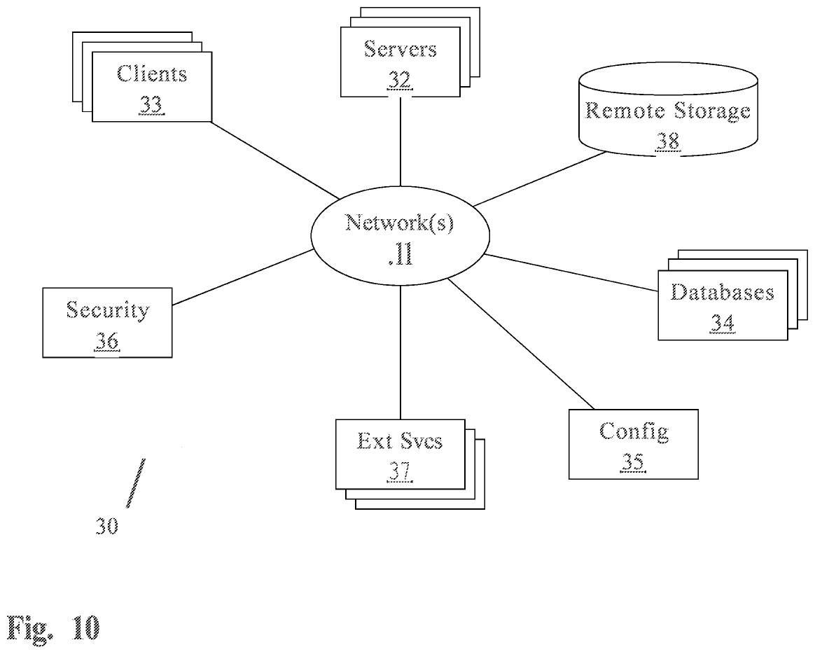

In some aspects, systems may be implemented on a distributed computing network, such as one having any number of clients and/or servers. Referring now to FIG. 10, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 9. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

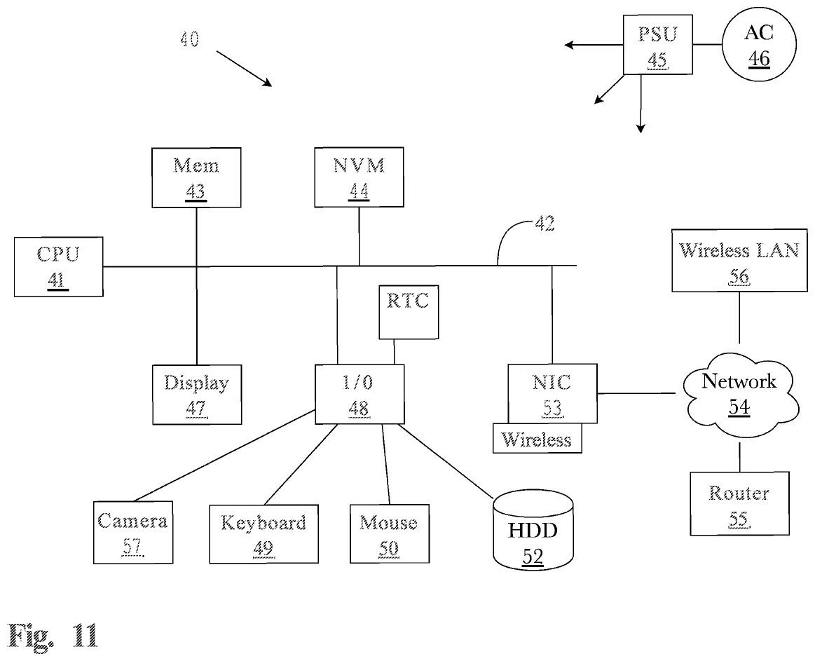

FIG. 11 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for advanced restaurant inventory management, comprising:
an inventory analysis server comprising at least a plurality of programming instructions stored in a memory of, and operating on at least one processor of, a computing device, wherein the plurality of programming instructions, when operating on the at least one processor, cause the computing device to:
receive a plurality of stored and third-party data pertaining to a restaurant comprising historical data regarding inventories, patrons, suppliers, social media postings, and business information and use machine learning to:
analyze at least a portion of the received data to determine optimal inventory levels;
analyze at least a portion of the received data predict future inventory requirements and to determine a quantity of items to be purchased based on those future inventory requirements;
generate a plurality of inventory adjustment suggestions based on predicted changes in consumption based on patron data, inventory data, and third-party data comprising at least a plurality of social media ratings and reviews pertaining to the restaurant;
generate a smart shopping list based on the determined quantity of items to be purchased and the inventory adjustment suggestions;
automatically order at least a portion of items on the smart shopping list for delivery to the restaurant; and
analyze at least a portion of the received data to determine a break-even point and to predict a dynamic point of reorder.

2. The system of claim 1, wherein the received business data comprises at least one of: point of sale data for a plurality of sales transactions, accounts receivable information for a plurality of suppliers, accounts payable information for a plurality of suppliers, financial account information for a plurality of banking institutions, or time and location descriptors.

3. The system of claim 1, wherein the retrieved inventory data comprises at least one of: a quantity of an item on-hand, a par level, a last re-order date, an expiration date, a shelf life value, or a forecasted reorder date; real-time third-party data, the real-time third-party data comprising at least one of: local news and events, current and forecasted weather, a social media posting, or a rating or review; and stored patron data comprising at least one of: a food item previously purchased, day and time data, weather conditions, local news and events, or preferences.

4. The system of claim 1, wherein the inventory adjustment suggestions generate menu adjustments for a restaurant based on patron trends, inventory availability, and external events.

5. The system of claim 1, wherein the machine learning comprises a long short term memory neural network.
